(19) United States
(12) Patent Application Publication
(10) Pub. No.: US 2003/0019829 A1
(43) Pub. Date: Jan. 30, 2003

(54) Nursing nipple protective sleeve structure

(76) Inventor: Te-Ta Huang, Chang Hua Hsien (TW)

Correspondence Address: BACON & THOMAS, PLLC, 625 Slaters Lane, 4th Floor, Alexandria, VA, 22314-1176, US

(21) Appl. No.: 09/915,266

(22) Filed: Jul. 27, 2001

(51) Int. Cl. A61J 9/08; A61J 17/00

(52) U.S. Cl. 215/11.6; 606/236

(57) ABSTRACT

A nursing nipple protective sleeve structure comprised of a nipple and a protective sleeve installed over the exterior section of the nipple. The nipple has a nursing end at one side and a round stay at the other side and, furthermore, disposed on the round stay is a grasping ring, with the protective sleeve fitted onto the round stay and covering the outer side of the nipple. Furthermore, a through-hole is formed at the two ends of the protective sleeve. The innovative feature is that the protective sleeve consists of two or more irregular tooth-shaped compression unit sections and, furthermore, one end of the protective sleeve is fitted onto the round stay and functions as an engagement end that provides for the conjoinment of the protective sleeve to the nipple. When the protective sleeve is compressed, the nursing end of the nipple projects beyond the through-hole and thereby provides for sucking by the infant. When the protective sleeve is no longer subjected to pressure, the compression unit sections immediately return to their original shape and once again surround the exterior of the nipple nursing end. As such, when the nipple is dropped, the nursing end is prevented from contacting the floor, the present invention thereby achieving hygienic and safe performance as an orally comfortable and protective pacifier nipple structure.

### BACKGROUND OF THE INVENTION

1) Field of the Invention

The invention herein relates to a nursing nipple protective sleeve structure in which the protective sleeve is fitted onto a round stay and covers the outer side of the nipple and, furthermore, the protective sleeve consists of three or more irregular tooth-shaped compression unit sections; when the protective sleeve is compressed, the nursing end of the nipple projects beyond a through-hole and thereby provides for sucking by the infant; when not utilized, the compression unit sections once again surround the exterior of the nipple nursing end; as such, when the nipple is dropped, the nursing end is prevented from contacting the floor, the present invention thereby achieving hygienic and safe performance as an orally comfortable and protective pacifier nipple structure.

2) Description of the Prior Art

In a conventional pacifier nipple, since the nursing end of the nipple is directly exposed, the nursing end contacts the floor when it is dropped and becomes covered with unclean substances and bacteria such that when use of the pacifier is resumed, the frail still unvaccinated infant is subjected to contagious pathogens and the resultant diseases thereof; patent Ser. No. 09/752,686 overcomes the said drawback and achieves hygienic and safe performance; however, due to its serpentine tubular structural arrangement, the length of the serpentine tube must exceed that of the nipple nursing end to effectively protect the nipple; furthermore, since each compression section is of a fixed length, compression occurs in a regular arrangement that decreases compression travel and consequently allows less of the nipple to be exposed, which results in oral sucking difficulty for the infant.

In view of the said situation, the inventor of the invention herein conducted research, development, and design that culminated in the successful development of the nursing nipple protective sleeve structure of the present invention.

### SUMMARY OF THE INVENTION

The primary objective of the invention herein is to provide a nursing nipple protective sleeve structure comprises of a nipple and a protective sleeve installed over the exterior section of the nipple; the protective sleeve is fitted onto a round stay and covers the outer side of the nipple, the protective sleeve consists of two or more irregular tooth-shaped compression unit sections, and a through-hole is formed at the two ends of the protective sleeve; one end of the protective sleeve is fitted onto the round stay and functions as an engagement end that provides for the conjoinment of the protective sleeve to the nipple; when the protective sleeve is compressed, the nursing end of the nipple projects beyond a through-hole and thereby provides for sucking by the infant; when not utilized, the compression unit sections once again surround the exterior of the nipple 1 nursing end; as such, when the nipple is dropped, the nursing end is prevented from contacting the floor, the present invention thereby achieving hygienic and safe performance as an orally comfortable and protective pacifier nipple structure.

Another objective of the invention herein is to provide a nursing nipple protective sleeve structure, wherein the large spacing interval of the tooth-shaped structure forming the compression unit sections of the said protective sleeve can be further increased to lengthen compression travel such that a greater extent of the nipple nursing end is projected (exposed) to provide the infant comfortable oral sucking performance.

### BRIEF DESCRIPTION OF THE DRAWINGS

FIG. 1 is an exploded drawing of the invention herein.

FIG. 2 is an isometric drawing of the invention herein.

FIG. 3 is a cross-sectional drawing of the invention herein before compression.

FIG. 4 is a cross-sectional drawing of the invention herein after compression.

FIG. 5 is an orthographic drawing of an embodiment of the invention herein.

FIG. 6 is an orthographic drawing of a single-section protective sleeve embodiment.

FIG. 6-A is an orthographic drawing of the single-section protective sleeve embodiment after compression.

FIG. 7 is an orthographic drawing of the nursing nipple during utilization.

### DETAILED DESCRIPTION OF THE INVENTION

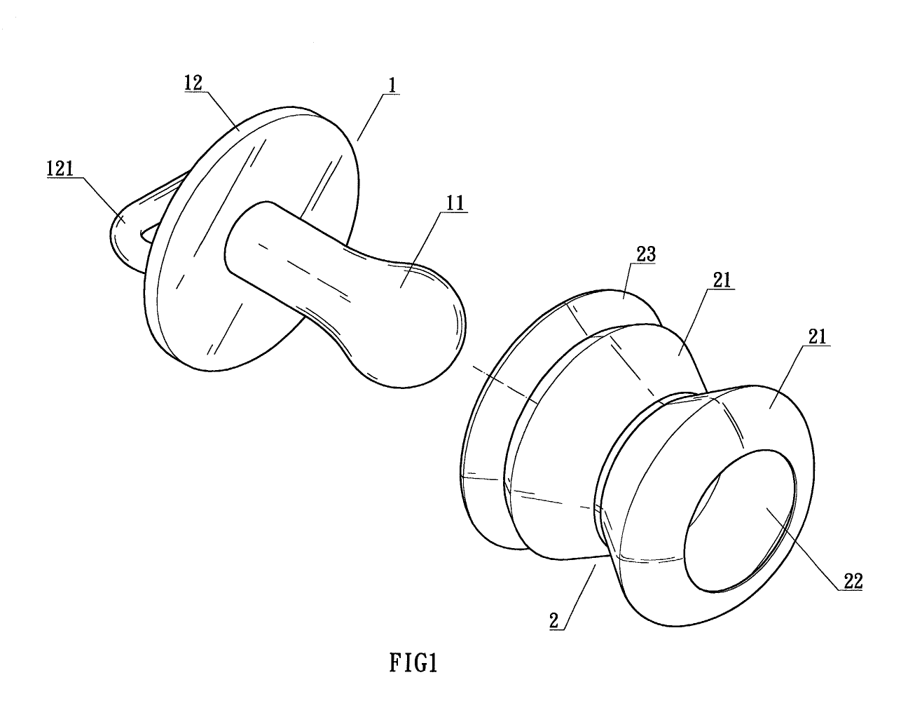

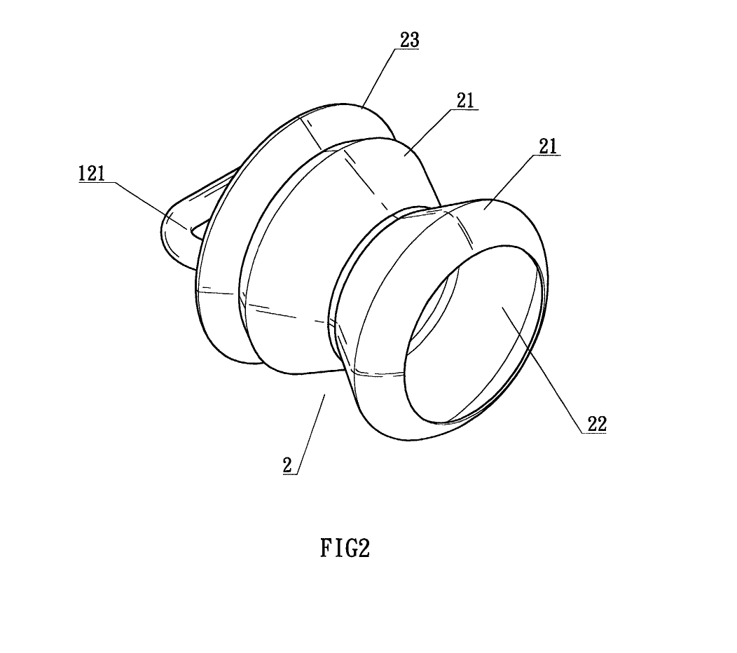

Referring to FIG. 1 and FIG. 2 the drawings of the structural arrangement of the present invention, the invention herein is comprised of a nipple 1 and a protective sleeve 2 installed over the exterior section of the nipple 1, of which:

The said nipple 1 has situated at one side a nursing end 11 and at the other side a round stay 12 and, furthermore, disposed on the round stay 12 is a grasping ring 121, with the protective sleeve 2 fitted onto the round stay 12 and covering the outer side of the nipple 1.

The said protective sleeve 2 consists of a hollow tubular structure surrounding the nipple 1 and, furthermore, the protective sleeve 2 consists of two or more irregular tooth-shaped compression unit 21 sections, with a through-hole 22 formed at the two ends of the protective sleeve 2; the tooth-shaped compression unit 21 section of the protective sleeve 2 nearest to the round stay 12 is fitted onto the round stay 12 and functions as an engagement end 23 that provides for the conjoinment of the protective sleeve 2 to the nipple 1.

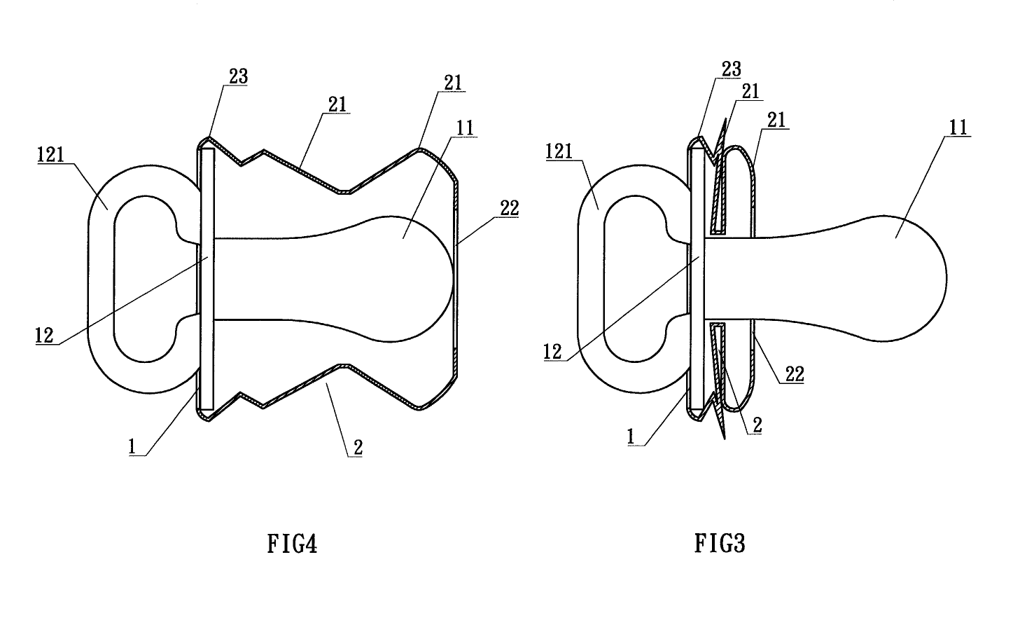

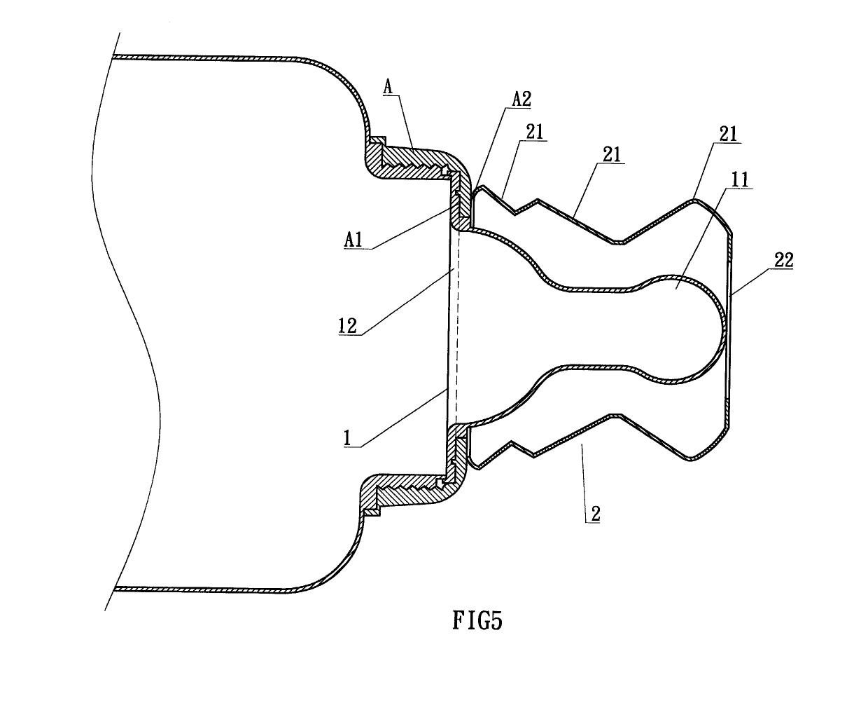

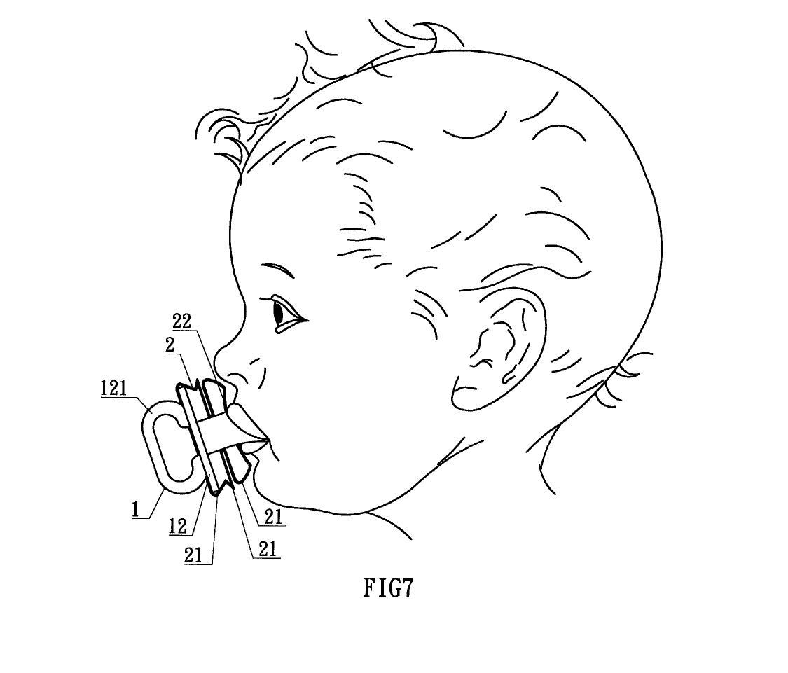

Referring to FIG. 3, FIG. 4, and FIG. 7, when an infant sucks the nipple 1 and the protective sleeve 2 is subjected to pressure, the nursing end 11 of the nipple 1 projects beyond the through-hole 22 and thereby provides for sucking by the infant; due to the large spacing interval of the tooth-shaped structure forming the compression unit 21 sections of the said protective sleeve 2, a greater extent of the nipple 1 nursing end 11 is projected (exposed) to provide the infant comfortable oral sucking performance (as shown in FIG. 3 and FIG. 7).

When the nipple 1 is removed from the mouth of the infant, the protective sleeve 2 is no longer compressed and the compression unit 21 sections immediately return to their original shape and once again surround the exterior of the nipple 1 nursing end 11 (as shown in FIG. 4); as such, when the nipple 1 is dropped, the nursing end 11 is prevented from contacting the floor, the present invention thereby achieving hygienic and safe performance as an orally comfortable and protective pacifier nipple structure.

Referring to FIG. 5, the embodiment of the invention herein installed to the front end of a nursing bottle, the round stay 12 of the nipple 1 is situated against the interior edge A1 of the nursing bottle cover A, the nursing end 11 of the nipple 1 is exposed at the outer periphery of the bottle cover A, and the protective sleeve 2 is fixed to the exterior edge A2 of the bottle cover A such that the protective sleeve 2 is capable of completely surrounding the nursing end 11 of the nipple 1.

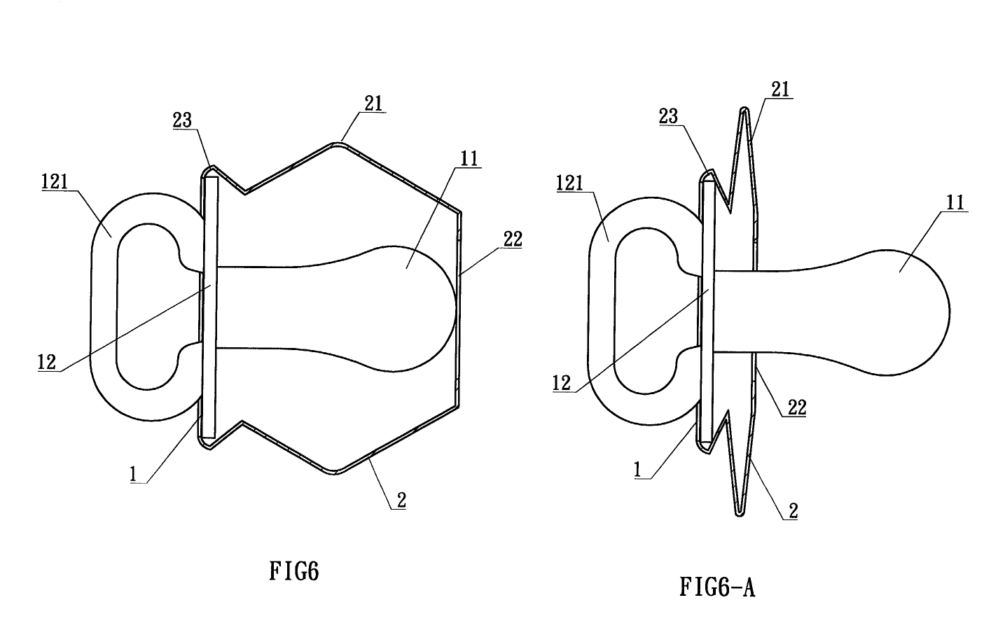

Referring to FIG. 6 and FIG. 6-A, since the length of nipple 1 nursing ends 11 differs, the length of protective sleeve 2 can be made adjustable by fabricating the protective sleeve 2 with a single-section compression unit 21.

1. A nursing nipple protective sleeve structure comprised of a nipple and a protective sleeve installed over the exterior section of the said nipple, of which:
The said nipple has situated at one side a nursing end and at the other side a round stay and, furthermore, disposed on the said round stay is a grasping ring, with the said protective sleeve fitted onto the said round stay and covering the outer side of the said nipple.
The said protective sleeve consists of a hollow tubular structure surrounding the said nipple and, furthermore, a through-hole formed at the two ends of the said protective sleeve, the innovative features of which are that the said protective sleeve consists of one more compression unit sections and the said compression unit section of the said protective sleeve nearest to the said round stay is fitted onto the said round stay and functions as an engagement end that provides for the conjoinment of the said protective sleeve to the said nipple.
As such, the present invention achieve hygienic and safe performance as an orally comfortable and protective pacifier nipple structure.

2. As mentioned in claim 1 of the nursing nipple protective sleeve structure of the invention herein, the said compression unit sections of the said protective sleeve consists of irregular tooth-shaped structures.

3. As mentioned in claim 1 of the nursing nipple protective sleeve structure of the invention herein, the large spacing interval of the tooth-shaped structure forming the said compression unit sections of the said protective sleeve can be further increased to lengthen compression travel such that a greater extent of the said nipple nursing end is projected (exposed) to provide the infant comfortable oral sucking performance.

4. As mentioned in claim 1 of the nursing nipple protective sleeve structure of the invention herein, the said round stay of the said nipple is installed against the interior edge of a nursing bottle cover, the said nursing end of the said nipple is exposed at the outer periphery of the said bottle cover, and the said protective sleeve is fixed to the exterior edge of the said bottle cover such that the said protective sleeve is capable of completely surrounding the said nursing end of the said nipple.
